(19) United States
(12) Patent Application Publication
(10) Pub. No.: US 2016/0349146 A1
(43) Pub. Date: Dec. 1, 2016

(54) APPARATUS FOR MEASURING GEAR TRANSMISSION ERROR

(71) Applicant: HYUNDAI MOTOR COMPANY, Seoul (KR)

(72) Inventor: Hyun Ku LEE, Seoul (KR)

(21) Appl. No.: 14/938,686

(22) Filed: Nov. 11, 2015

(30) Foreign Application Priority Data
May 26, 2015 (KR) 10-2015-0072665

(51) Int. Cl. G01M 13/02

(52) U.S. Cl. CPC G01M 13/021

(57) ABSTRACT

A gear transmission error measuring apparatus for measuring a transmission error of a gear power train, the gear transmission error measuring apparatus includes a measurement jig for rotatably supporting a rotational shaft of the gear power train, an encoder installed in the rotational shaft of the gear power train for measuring rotation information of the rotational shaft, and a transmission error calculator connected to the encoder for calculating a transmission error of a gear set.

### CROSS-REFERENCE TO RELATED APPLICATION

This application claims the benefit of priority to Korean Patent Application No. 10-2015-0072665, filed on May 26, 2015 with the Korean Intellectual Property Office, the disclosure of which is incorporated herein in its entirety by reference.

### TECHNICAL FIELD

The present disclosure relates to an apparatus for measuring a transmission error of a gear and, more particularly, to a gear transmission error measuring apparatus for simply and precisely measuring a gear transmission error with respect to a gear power train.

### BACKGROUND

As is widely known, a gear power train such as a gear train or a gear box is configured such that at least a pair of gears are engaged to transmit power. In such a gear power train, a transmission error may occur between a pair of gears, and such a transmission error is measured based on a difference in rotational speeds between a driving gear and a following gear according to rotational speeds of the driving gear and the following gear.

In particular, such a transmission error refers to a deviation that occurs between a theoretical angular position and an actual angular position of the following gear as the driving gear rotates at a predetermined speed.

The transmission error occurring between mutually engaged gears may be measured by various types of gear transmission error measurement apparatuses.

When a gear transmission error of a gear power train including a plurality of gears, such as a transmission for a vehicle, is intended to be measured by a related art gear transmission error measurement apparatus, gears as measurement targets, among the plurality of gears, are individually coupled to a shaft by arbors and a transmission error between mutually engaged gears is measured.

Thus, in the related art gear transmission error measurement apparatus, in order to measure a transmission error between gears as measurement targets of the gear power train having a plurality of gear sets, the arbor for coupling the gears to be measured to a shaft needs to be individually manufactured, significantly increasing cost. Assembly is difficult and it is not easy to quickly and precisely measure a transmission error.

For example, in a gear power train having a plurality of stages of gear sets such as a 7-shift transmission, an arbor for coupling gears at each stage to a shaft should be individually manufactured, and thus, 7 pairs of arbors need to be individually manufactured to correspond to each gear. In particular, the arbors for fixing the gears to the shaft should be individually manufactured according to dimensions of corresponding gears, increasing manufacturing cost. Since the gears should be assembled by the arbors corresponding thereto, assembling thereof is not easy. Also, it is difficult to check accurate dimensions of the corresponding gears, causing a difference in actual performance to result in an error in measuring a transmission error.

### SUMMARY OF THE DISCLOSURE

The present disclosure has been made to solve the above-mentioned problems occurring in the prior art while advantages achieved by the prior art are maintained intact.

An aspect of the present disclosure provides a gear transmission error measuring apparatus capable of simply and precisely measuring a transmission error between mutually engaged gears of a gear power train having a plurality of gear sets such as a transmission for a vehicle.

According to an exemplary embodiment of the present disclosure, a gear transmission error measuring apparatus for measuring a transmission error of a gear power train having two or more rotational shafts and a plurality of mutually engaged gear sets provided at the two or more rotational shafts, includes: a measurement jig configured to rotatably support each of the two or more rotational shafts of the gear power train; two or more encoders respectively installed in the two or more rotational shafts of the gear power train and configured to measure rotation information of the two or more rotational shafts; and a transmission error calculator connected to the two or more encoders and configured to calculate a transmission error of a selected gear set.

The transmission error calculator may be configured to calculate a transmission error of a selected gear set by using a difference in rotation information of the two or more rotational shafts respectively measured by the two or more encoders.

The measurement jig may have a rotation support part configured to rotatably support one ends of the two or more rotational shafts.

The two or more encoders may be installed at the other ends of the two or more rotational shafts.

The gear transmission error measuring apparatus may further include driving units connected to rotate the two or more rotational shafts, respectively, wherein the driving units may be connected to the other ends of the two or more rotational shafts through connection members.

The two or more encoders may be configured as hollow shaft encoders each having a hollow portion formed therein, and portions of the connection members may be inserted into the hollow portions of the two or more encoders.

One ends of the connection members may be fixed to the other ends of the two or more rotational shafts, and the driving units may be connected to the other ends of the connection members.

Each of the connection members may have a fixed portion formed at one end thereof and a head portion formed at the other end thereof, the fixed portion may be fixed to the other end of each of the two or more rotational shafts and each of the driving units may be connected to the head portion.

The driving units may be electric motors, and an output shaft of each of the electric motors may be coupled to the other end of each of the connection members.

The measurement jig may have a support body formed to have a length corresponding to those of the two or more rotational shafts of the gear power train and a rotation support part configured to rotatably support one ends of the two or more rotational shafts.

The rotation support part may protrude outwardly from the jig body and have rotation support members rotatably supporting one ends of the two or more rotational shafts therein.

According to another exemplary embodiment of the present disclosure, a gear transmission error measuring apparatus includes: a measurement jig configured to support a gear power train having two or more rotational shafts and a plurality of mutually engaged gear sets provided in the two or more rotational shafts; two or more encoders configured to measure rotation speeds of the two or more rotational shafts, respectively; a driving unit connected to at least one of the two or more rotational shafts to rotate the corresponding rotational shaft; and a transmission error calculator electrically connected to the two or more encoders and configured to calculate a transmission error of a selected gear set, wherein the transmission error calculator calculates a transmission error of the selected gear set by using a difference in rotation speeds measured by the two or more encoders.

The driving unit may be configured as a plurality of electric motors, and the plurality of electric motors may be individually connected to the two or more rotational shafts.

According to another exemplary embodiment of the present disclosure, a gear transmission error measuring method for measuring a transmission error of a selected gear set of a gear power train by the aforementioned gear transmission error measuring apparatus, includes: selecting any one gear set from the gear power train; rotating any one of the two or more rotational shafts; outputting rotation information regarding the two or more rotational shafts by the two or more encoders, respectively, and calculating a transmission error of the selected gear set by using a difference in the output rotation information.

Specific matters of other exemplary embodiments are included in the detailed description and drawings.

### BRIEF DESCRIPTION OF THE DRAWINGS

The above and other objects, features and advantages of the present disclosure will be more apparent from the following detailed description taken in conjunction with the accompanying drawings.

FIG. 1 is a view illustrating a configuration of an apparatus for measuring a transmission error of a gear according to an exemplary embodiment of the present disclosure, in which a gear power train having two rotational shafts is applied.

FIG. 2 is a view illustrating a configuration in which a gear power train having three rotational shafts is applied to an apparatus for measuring a transmission error of a gear according to an exemplary embodiment of the present disclosure.

### DETAILED DESCRIPTION

Hereinafter, the exemplary embodiment of the present disclosure will be described in detail with reference to the accompanying drawings. For reference, dimensions of elements or thicknesses of lines illustrated in the drawings referred to describe the present disclosure may be exaggerated for the convenience of understanding. Also, the terms used henceforth have been defined in consideration of the functions of the present invention, and may be altered according to the intent of a user or operator, or conventional practice. Therefore, the terms should be defined on the basis of the entire content of this specification.

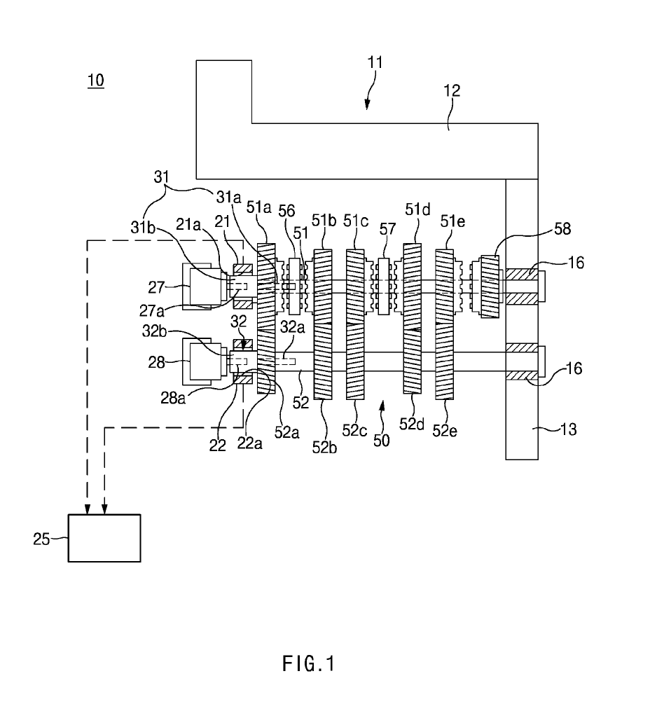

FIG. 1 is a view illustrating a configuration of an apparatus for measuring a transmission error of a gear according to an exemplary embodiment of the present disclosure.

Referring to FIG. 1, the apparatus for measuring a transmission error of a gear according to an exemplary embodiment of the present disclosure includes a measurement jig 11 supporting gear power train 50 having two or more rotational shafts 51 and 52, and two or more encoders 21 and 22 measuring rotational information (rotational speed and/or phase) regarding the two or more rotational shafts 51 and 52 supported by the measurement jig 11.

The measurement jig 11 has a support body 12 and a rotation support part 13, and the gear power train 50, such as a transmission for a vehicle, is installed in the measurement jig 11.

FIG. 1 illustrates a state in which the gear power train 50 having the two rotational shafts 51 and 52 is installed in the measurement jig 11.

The gear power train 50 of FIG. 1 has a first rotational shaft 51 and a second rotational shaft 52 arranged to be parallel to each other.

A plurality of first gears 51a, 51b, 51c, 51d, and 51e are installed on an outer circumferential surface of the first rotational shaft 51 such that they freely rotate with respect to the first rotational shaft 51, and a plurality of second gears 52a, 52b, 52c, 52d, and 52e are fixedly installed on an outer circumferential surface of the second rotational shaft 52. As the plurality of first gears 51a, 51b, 51c, 51d, and 51e and the plurality of second gears 52a, 52b, 52c, 52d, and 52e are engaged to correspond to each other, forming a plurality of gear sets 51a and 52a, 51b and 52b, 51c and 52c, 51d and 52d, and 51e and 52e.

Selection members 56, 57, and 58 such as a synchronizer or a dog clutch are disposed between the plurality of first gears 51a, 51b, 51c, 51d, and 51e. As the selection members 56, 57, and 58 are selectively engaged with at least any one of the plurality of first gears 51a, 51b, 51c, 51d, and 51e, at least one of the plurality of first gears 51a, 51b, 51c, 51d, and 51e is selectively coupled to the first rotational shaft 51, and accordingly, at least one gear set, among a plurality of gear sets 51a and 52a, 51b and 52b, 51c and 52c, 51d and 52d, and 51e and 52e, may be selected. For example, in a case in which the gear power train of FIG. 1 is a gear power train for a transmission, the selected gear set may form a predetermined stage such as a first stage, a second stage, a third stage, a fourth stage, a fifth stage, an Nth stage, and a reverse stage.

The first and second rotational shafts 51 and 52 of the gear power train are installed to be rotatably supported by a rotation support part 13 of the measurement jig 11.

The support body 12 of the measurement jig 11 may have a size having a length corresponding to those of the first and second rotational shafts 51 and 52.

The rotation support part 13 extends to protrude outwardly from one end of the support body 12 and has through holes through which one ends of the first and second rotational shafts 51 and 52 are inserted. Rotation support members 16 such as bearings, or the like, rotatably supporting the first and second rotational shafts 51 and 52 are installed in the through holes.

Driving units 27 and 28 are connected to the first and second rotational shafts 51 and 52 and rotate at least any one of the first and second rotational shafts 51 and 52.

According to an exemplary embodiment, the driving units 27 and 28 include first and second electric motors 27 and 28 connected to the other ends of the first and second rotational shafts 51 and 52. Either the first rotational shaft 51 or the second rotational shaft 52 may be stably rotated at a predetermined speed by driving any one of the two electric motors 27 and 28.

The first and second electric motors 27 and 28 may be connected to the other ends of the rotational shafts 51 and 52 by the medium of connection members 31 and 32, respectively, and in particular, one set of ends of the connection members 31 and 32 are respectively fixed to the other ends of the rotational shafts, and the other set of ends of the connection members 31 and 32 are respectively connected to the first and second electric motors 27 and 28.

The connection members 31 and 32 have fixed portions 31a and 32a formed at one set of ends thereof and head portions 31b and 32b formed at the other set of ends thereof, respectively. The fixed portions 31a and 32a of the connection members 31 and 32 are insertedly fixed in the other set of ends of the rotational shafts 51 and 52, respectively, and the head portions 31b and 32b of the connection members 31 and 32 are disposed to be outwardly exposed at the other set of ends of the rotational shafts 51 and 52, respectively. Output shafts 27a and 28a of the electric motors 27 and 28 as examples of driving units, are coupled to the head portions 31b and 32b of the connection members 31 and 32, respectively, whereby a driving force from the electric motors 27 and 28 may be smoothly transmitted to the rotational shafts 51 and 52 through the connection members 31 and 32.

Alternatively, the driving unit may be installed only at any one rotational shaft serving as a driving shaft, among the first and second rotational shafts 51 and 52. For example, in a case in which the first rotational shaft 51 serves as a driving shaft in the gear power train 50 of FIG. 1, the first electric motor 27 may be connected only to the other end of the first rotational shaft 51 and the second electric motor 28 may not be installed in the other end of the second rotational shaft 52.

The encoders 21 and 22 may include first and second encoders 21 and 22 installed at the other set of ends of the first and second rotational shafts 51 and 52, respectively. The first and second encoders 21 and 22 may individually measure rotation information such as rotation speeds and/or phases of the first and second rotational shafts 51 and 52, respectively.

According to an exemplary embodiment, the encoders 21 and 22 may be configured as hollow-shaft encoders having hollow portions 21a and 22a therein, respectively.

Portions of the connection members 31 and 32, that is, the head portions 31b and 32b, may be inserted into the hollow portions 21a and 22a of the encoders 21 and 22, respectively. Accordingly, in a state in which the encoders 21 and 22 are coupled to the head portions 31b and 32b of the connection members 31 and 32, the encoders 21 and 22 may precisely measure rotation information (rotation speeds and/or phases) of the rotational shafts 51 and 52, respectively.

A transmission error calculator 25 may be electrically connected to the first and second encoders 21 and 22. The transmission error calculator 25 receives the rotation information (rotation speeds and/or phases) of the rotational shafts 51 and 52 from the first and second encoders 21 and 22, and may precisely calculate a transmission error regarding the selected gear sets 51a and 52a, 51b and 52b, 51c and 52c, 51d and 52d, and 51e and 52e of the gear power train 50 by using, or analyzing, a difference in the rotation information of the encoders 21 and 22.

The measurement process (measurement method) of the present disclosure will be described in more detail.

When any one of the first gears 51a, 51b, 51c, 51d, and 51e is selectively coupled to the first rotational shaft 51 by the selection members 56, 57, and 58 of the gear power train 50, at least one of the plurality of gear sets 51a and 52a, 51b and 52b, 51c and 52c, 51d and 52d, and 51e and 52e is selected.

In a state in which the any one gear set is selected, when any one of the first and second rotational shafts 51 and 52 is rotated by the driving units 27 and 28, the encoders 21 and 22 may precisely measure rotation information (rotation speeds and/or phases) of the first and second rotational shafts 51 and 52 corresponding to the selected gear set.

After the rotation information (rotation speeds and/or phases) of the first and second rotational shafts 51 and 52 corresponding to the mesh state of the selected gear set is measured by the encoders 21 and 22, the rotation information is input to the transmission error calculator 25, and the transmission error calculator 25 may precisely calculate a transmission error of the selected gear set by using, or analyzing, the difference in the input rotation information.

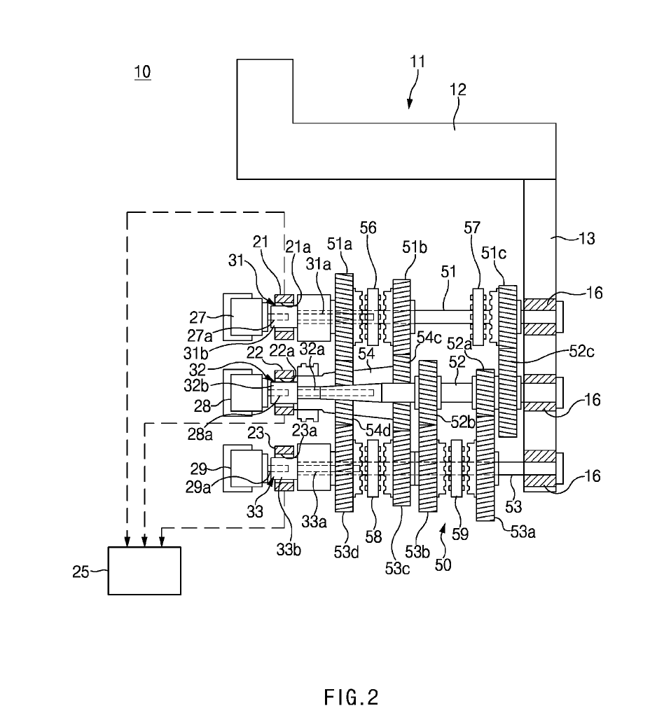

FIG. 2 is a view illustrating a state in which the gear power train 50 having three rotational shafts 51, 52, and 53 is installed in the apparatus for measuring a transmission error of a gear according to an exemplary embodiment of the present disclosure. Referring to FIG. 2, in the apparatus for measuring a transmission error of a gear of the present disclosure, three rotational shafts 51, 52, and 53 are rotatably supported by the rotation support part 13 of the measurement jig 11, and three encoders 31, 32, and 33, and three driving units 27, 28, and 29 are applied to correspond to the three rotational shafts 51, 52, and 53.

The gear power train 50 of FIG. 2 has a first rotational shaft 51, a second rotational shaft 52, and a third rotational shaft 53 arranged to be parallel to each other.

A plurality of first gears 51a, 51b, and 51c are installed on an outer circumferential surface of the first rotational shaft 51 such that the plurality of first gears 51a, 51b, and 51c freely rotate with respect to the first rotational shaft 51, and selection members 56 and 57 such as a synchronizer or a dog clutch are disposed between the plurality of first gears 51a, 51b, and 51c.

A plurality of second gears 52a and 52b are fixedly installed on an outer circumferential surface at one side of the second rotational shaft 52.

A hollow outer member 54 is installed on an outer circumferential surface at the other side of the second rotational shaft 52, and a plurality of outer gears 54c and 54d are fixedly installed in the hollow outer member 54.

A plurality of third gears 53a, 53b, 53c, and 53d is installed on an outer circumferential surface of the third rotational shaft 53 such that the plurality of third gears 53a, 53b, 53c, and 53d freely rotate with respect to the third rotational shaft 53. Selection members 58 and 59 such as a synchronizer or a dog clutch are disposed between the plurality of third gears 53a, 53b, 53c, and 53d.

As the plurality of first gears 51a, 51b, and 51c, the plurality of second gears 52a and 52b, the plurality of outer gears 54a and 54b, and the plurality of third gears 53a, 53b, 53c, and 53d are engaged with each other, gear sets 51a and 54d, 51b and 54c, 51c and 52c, 53a and 52a, 53b and 52b, 53c and 54c, 53d and 54d may be formed.

Accordingly, as the selection members 56 and 57 of the first rotational shaft 51 and/or the selection members 58 and 59 of the third rotational shaft 53 are selectively engaged with any one of the plurality of first gears 51a, 51b, and 51c and the plurality of third gears 53a, 53b, 53c, and 53d, the any one first gear 51a, 51b, or 51c may be selectively coupled to the first rotational shaft 51 or any one third gear 53a, 53b, 53c, or 53d may be selectively coupled to the third rotational shaft 53, whereby at least any one of the gear sets 51a and 54d, 51b and 54c, 51c and 52c, 53a and 52a, 53b and 52b, 53c and 54c, and 53d and 54d may be selected. For example, in a case in which the gear power train of FIG. 2 is a gear power train for a transmission, the selected gear set may form a predetermined stage such as a first stage, a second stage, a third stage, a fourth stage, a fifth stage, an Nth stage, and a reverse stage.

Other configurations and operations of the measurement jig 11, the encoders 31, 32, and 33, the connection members 21, 22, and 23, the driving units 27, 28, and 29, and the transmission error calculator 25 are the same as, or similar to, those of the exemplary embodiment of FIG. 1, and thus, detailed descriptions thereof will be omitted.

As described above, according to exemplary embodiments of the present disclosure, by installing the gear power train having a plurality of gear sets such as a transmission for a vehicle, and having two or more rotational shafts with a plurality of gears installed therein in the measurement jig, a transmission error between mutually engaged gears of the gear power train may be simply and precisely measured, and in particular, since a separate fixing member for coupling each gear to the shafts is not required, measurement cost may be reduced.

Although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A gear transmission error measuring apparatus for measuring a transmission error of a gear power train, the gear transmission error measuring apparatus comprising:
a measurement jig for rotatably supporting a rotational shaft of the gear power train;
an encoder installed in the rotational shaft of the gear power train for measuring rotation information of the rotational shaft; and
a transmission error calculator connected to the encoder for calculating a transmission error of a gear set.

2. The gear transmission error measuring apparatus according to claim 1, wherein the gear power train has two or more rotational shafts and a plurality of mutually engaged gear sets provided at the two or more rotational shafts, and the encoder is configured as two or more encoders respectively installed in the two or more rotational shafts.

3. The gear transmission error measuring apparatus according to claim 2, wherein the transmission error calculator calculates a transmission error of a gear set selected from among the plurality of gear sets by using a difference in rotation information of the two or more rotational shafts respectively measured by the two or more encoders.

4. The gear transmission error measuring apparatus according to claim 1, wherein the measurement jig has a rotation support part for rotatably supporting one set of ends of the two or more rotational shafts.

5. The gear transmission error measuring apparatus according to claim 4, wherein the two or more encoders are respectively installed at the other set of ends of the two or more rotational shafts.

6. The gear transmission error measuring apparatus according to claim 5, further comprising driving units connected to rotate the two or more rotational shafts, respectively, wherein the driving units are connected to the other set of ends of the two or more rotational shafts through connection members.

7. The gear transmission error measuring apparatus according to claim 6, wherein the two or more encoders are configured as hollow shaft encoders each having a hollow portion formed therein, and portions of the connection members are inserted into the hollow portions of the two or more encoders.

8. The gear transmission error measuring apparatus according to claim 7, wherein one ends of the connection members are fixed to the other set of ends of the two or more rotational shafts, and the driving units are connected to the other set of ends of the connection members.

9. The gear transmission error measuring apparatus according to claim 8, wherein each of the connection members has a fixed portion formed at one end thereof and a head portion formed at the other end thereof, the fixed portion is fixed to the other end of each of the two or more rotational shafts and each of the driving units is connected to the head portion.

10. The gear transmission error measuring apparatus according to claim 9, wherein the driving units are electric motors, and an output shaft of each of the electric motors is coupled to the other end of each of the connection members.

11. The gear transmission error measuring apparatus according to claim 4, wherein the measurement jig has a support body formed to have a length corresponding to those of the two or more rotational shafts of the gear power train and a rotation support part configured to rotatably support one set of ends of the two or more rotational shafts.

12. The gear transmission error measuring apparatus according to claim 11, wherein the rotation support part protrudes outwardly from the jig body and has rotation support members rotatably supporting one set of ends of the two or more rotational shafts therein.

13. A gear transmission error measuring apparatus comprising:
a measurement jig for supporting a gear power train having a mutually engaged gear set;
an encoder for individually measuring a rotation speed of a rotational shaft;
a driving unit for rotating the rotational shaft; and
a transmission error calculator electrically connected to the encoder for calculating a transmission error of the gear set,
wherein the transmission error calculator calculates a transmission error of the gear set by using a rotation speed measured by the encoder.

14. The gear transmission error measuring apparatus according to claim 13, wherein the gear power train has two or more rotational shafts and a plurality of mutually engaged gear sets provided at the two or more rotational shafts, and the encoder is configured as two or more encoders respectively installed in the two or more rotational shafts.

15. The gear transmission error measuring apparatus according to claim 14, wherein the driving units are configured as a plurality of electric motors, and the plurality of electric motors is individually connected to the two or more rotational shafts.

16. A gear transmission error measuring method for measuring a transmission error of a selected gear set of a gear power train by the aforementioned gear transmission error measuring apparatus according to claim 1, the method comprising:
selecting any one gear set from the gear power train;
rotating any one of the two or more rotational shafts;
outputting rotation information regarding the two or more rotational shafts, respectively; and
calculating the transmission error of the selected gear set by using a difference in the output rotation information.

17. The gear transmission error measuring method according to claim 16, wherein rotation information regarding the two or more rotational shafts are respectively measured by the two or more encoders.
